(19) United States
(12) Patent Application Publication
(10) Pub. No.: US 2009/0301281 A1
(43) Pub. Date: Dec. 10, 2009

(54) Driving Device For Reciprocation Movement of a Saw Blade of a Scroll Sawing Machine

(75) Inventor: Jung-Huo Chen, Tali (TW)

Correspondence Address: Sunstein Kann Murphy & Timbers LLP, 125 SUMMER STREET, BOSTON, MA, 02110-1618, US

(73) Assignee: REXON INDUSTRIAL CORP., LTD., Tali (TW)

(21) Appl. No.: 12/474,537

(22) Filed: May 29, 2009

(30) Foreign Application Priority Data
Jun. 4, 2008 (TW) 097120723

(51) Int. Cl. B23D 51/16

(52) U.S. Cl. 83/604

(57) ABSTRACT

A driving device for a scroll sawing machine includes upper and lower head bodies, each having a nose segment which is turnable by a reciprocating force of an arm, upper and lower straightening members each adapted to grip an end of the saw blade, and upper and lower linkage members each including a hanging end which is connected to the nose segment, a holding end which is connected to the respective straightening member, and a linking segment which defines with the holding end a straight line that is parallel to a running path of the saw blade such that, when the nose segment is turned, the linking segment can be lifted or lowered so as to keep the holding end in the straight line.

### CROSS-REFERENCE TO RELATED APPLICATION

This application claims priority of Taiwanese Patent Application No. 097120723, filed on Jun. 4, 2008, the disclosure of which is herein incorporated by reference.

### BACKGROUND OF THE INVENTION

1. Field of the Invention

This invention relates to a scroll sawing machine, more particularly to a driving device for driving reciprocating movement of a saw blade of a scroll sawing machine.

2. Description of the Related Art

Referring to FIG. 1, a conventional scroll saw disclosed in U.S. Pat. No. 6,393,957 B1 is shown to include a linkage unit 1, a driving unit 2 disposed to drive the linkage unit 1 to perform reciprocating displacement, two swing arms 3 coupled to the linkage unit 1, two blade holders 4 pivotally and respectively mounted to rear ends of the swing arms 3, and a saw blade 5 securely connected to the blade holders 4. The linkage unit 1 includes upper and lower driving arms 101, 102 and a linking lever 103 pivotally connected to the upper and lower driving arms 101, 102. The linking lever 103 is pivotally mounted on a machine base (not shown) at a middle portion thereof. Each swing arm 3 has a pivot portion 301 pivotally mounted on the machine base. When the linkage unit 1 is driven by the driving unit 2 to result in reciprocating displacement of the upper and lower driving arms 101, 102, the swing arms 3 are swung about the pivot portion 301 so as to result in running movement of the saw blade 5 in an upright direction for performing a sawing operation.

However, due to the swinging motion of the swing arms 3, the saw blade 5 may sway (as indicated by solid and dotted lines illustrated in FIG. 1) during a sawing operation, which may result in breakage of the saw blade 5. Furthermore, vibration of the machine base renders the sawing operation unstable.

### SUMMARY OF THE INVENTION

An object of the present invention is to provide a driving device which can drive a saw blade of a scroll sawing machine to perform stable and straight reciprocating movement so as to prevent breakage of the saw blade.

According to this invention, the driving device includes a linking member, upper and lower arms coupled to the linking member and respectively having upper and lower actuating ends, a drive unit disposed to synchronously deliver upper and lower reciprocating forces to move the upper and lower arms, respectively, a head body unit including upper and lower head bodies, a saw-blade straightening unit including upper and lower straightening members, and a linkage unit including upper and lower linkage members. Each head body has a pivoted region pivotally mounted on a frame of a scroll sawing machine about a fulcrum axis, and an anchored region connected to a respective one of the upper and lower actuating ends of the upper and lower arms, and extends forwardly to terminate at a nose segment which has outer and inner regions opposite to each other in an upright direction and which is turnable about the fulcrum axis. Each straightening member has a securing end adapted to grip a tightened end of a saw blade, and a connecting end opposite to the securing end. Each linkage member includes a hanging end connected to the outer region, a holding end connected to the connecting end, and a linking segment which defines with the holding end a straight line that is parallel to a running path of the saw blade such that, when the outer region is turned about the fulcrum axis, the linking segment is lifted or lowered along the straight line so as to remain in the straight line with the holding end.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic plan view illustrating the operation of a conventional scroll saw;

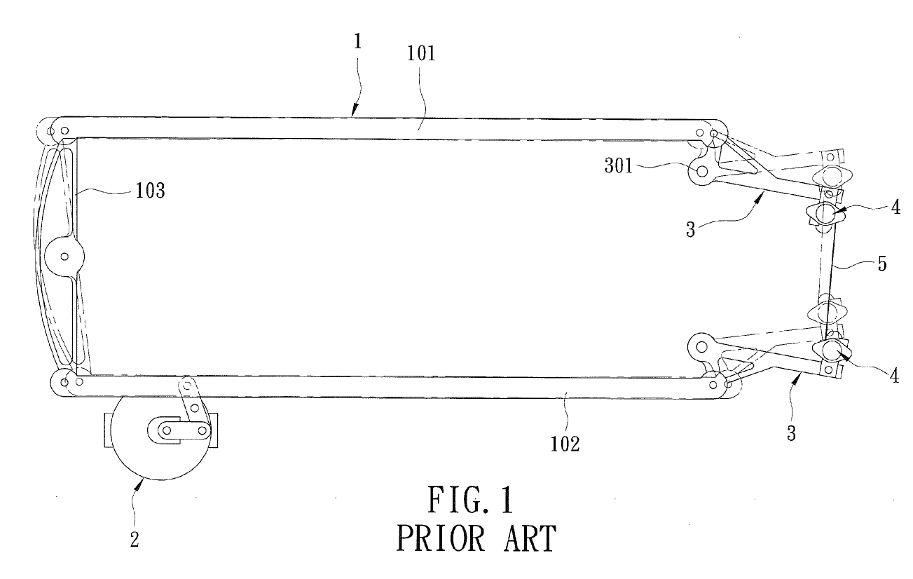

FIG. 2 is a perspective view of the preferred embodiment of a driving device according to this invention when incorporated in a scroll sawing machine;

FIG. 3 is a schematic plan view of the preferred embodiment when incorporated in the scroll sawing machine;

FIG. 4 is an exploded perspective view of the preferred embodiment;

FIG. 5 is a schematic view illustrating a downward running movement of the preferred embodiment;

FIG. 6 is a schematic view illustrating an upward running movement of the preferred embodiment; and

FIG. 7 is a partly cross-sectional view of a blade tensioning unit taken along lines VII-VII of FIG. 6.

### DETAILED DESCRIPTION OF THE PREFERRED EMBODIMENT

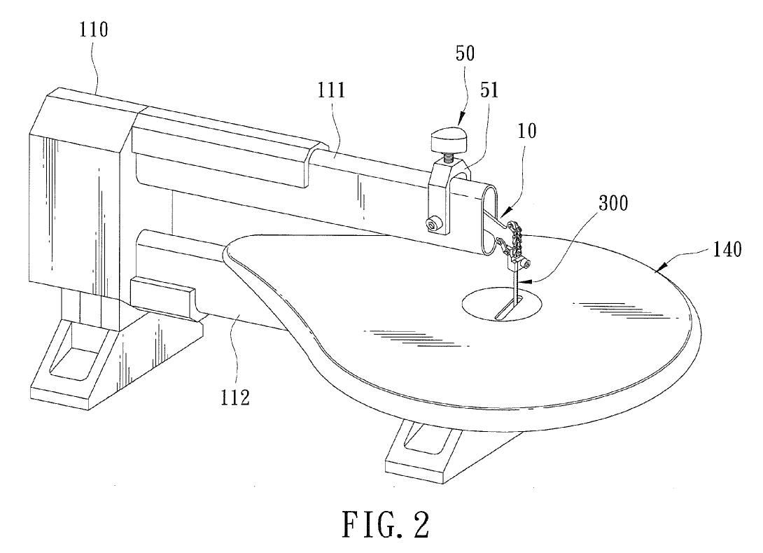

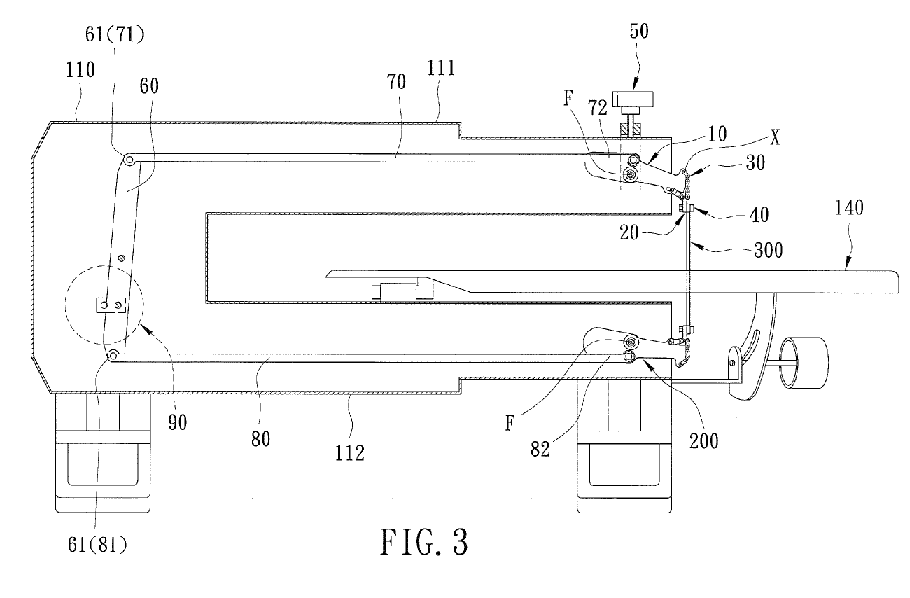

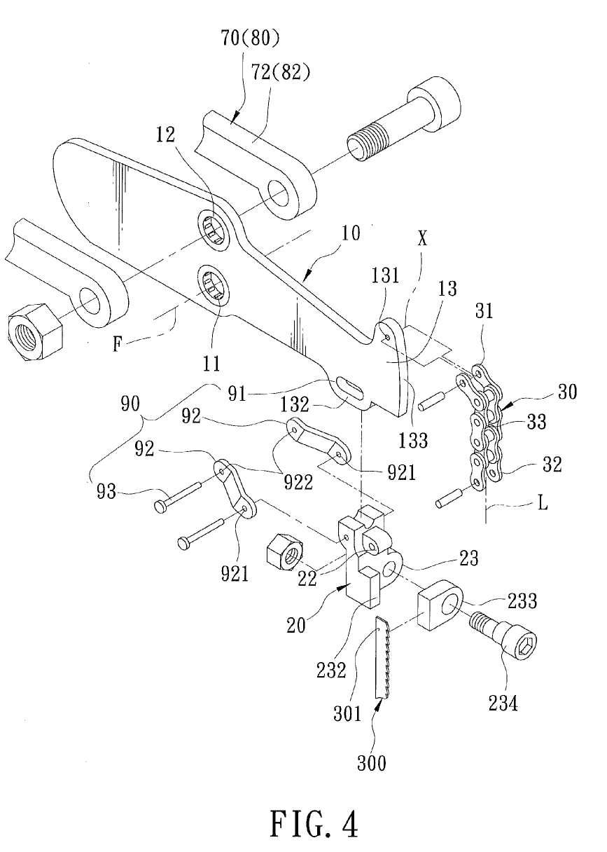

Referring to FIGS. 2 to 4, the preferred embodiment of a driving device according to the present invention is shown to be connected to an elongate saw blade 300 of a scroll sawing machine 100. The scroll sawing machine 100 includes an upright frame segment 110, a cantilevered frame segment 111 extending forwardly from an upper end of the upright frame segment 110, and an underlying frame segment 112 extending forwardly from a lower end of the upright frame segment 110 and spaced apart from the cantilevered frame segment 111 in an upright direction to define a working space for mounting a worktable 140. The saw blade 300 has upper and lower tightened ends 301, and is disposed forwardly of the working space. The saw blade 300 is straightened so as to be moved reciprocatingly along a running path in the upright direction.

The driving device of this embodiment comprises a linking member 60, upper and lower arms 70, 80, a drive unit 90, a head body unit including upper and lower head bodies 10, a saw-blade straightening unit including upper and lower straightening members 20, a linking unit including upper and lower linkage members 30, and a blade tension adjusting unit 50.

The linking member 60 is pivotally mounted to the upright segment 110, and has upper and lower linking ends 61. The upper arm 70 extends along the cantilevered frame segment 111, and has an upper linked end 71 coupled to the upper linking end 61, and an upper actuating end 72 opposite to the upper linked end 71 in a longitudinal direction that is transverse to the upright direction. The lower arm 80 extends along the underlying frame segment 112 and has a lower linked end 81 coupled to the lower linking end 61, and a lower actuating end 82 opposite to the lower linked end 81 in the longitudinal direction. The drive unit 90 is disposed to synchronously deliver upper and lower reciprocating forces to move the upper and lower arms 70, 80, respectively, in the longitudinal direction.

Each of the upper and lower head bodies 10 has a pivoted region 11 which is adapted to be pivotally mounted on a respective one of the cantilevered and underlying frame segments 111, 112 about a fulcrum axis (F), and an anchored region 12 which is connected to a respective one of the upper and lower actuating ends 72, 82 of the upper and lower arms 70, 80. Each of the upper and lower head bodies 10 further extends forwardly to terminate at a nose segment 13 which has outer and inner regions 131, 132 opposite to each other in the upright direction so that the outer region 131 is turnable about the fulcrum axis (F), and an engaging surface 133 facing forwardly.

Each of the upper and lower straightening members 20 has a securing end 23 that is adapted to grip a respective one of the upper and lower tightened ends 301 of the saw blade 300, and a connecting end 22 that is opposite to the securing end 23. Specifically, the securing end 23 has a left jaw wall 232 which extends in the longitudinal direction, a right jaw wall 233 which is movable relative to the left jaw wall 232 in a transverse direction relative to both the longitudinal and upright directions so as to cooperate with the left jaw wall 232 to grip the respective tightened end 301, and a locking member 234 which is operable to move the right jaw wall 233 toward the left jaw wall 232. In this embodiment, the locking member 234 has a cam mechanism which is configured such that turning of the locking member 234 results in displacement of the right jaw wall 233 in the transverse direction.

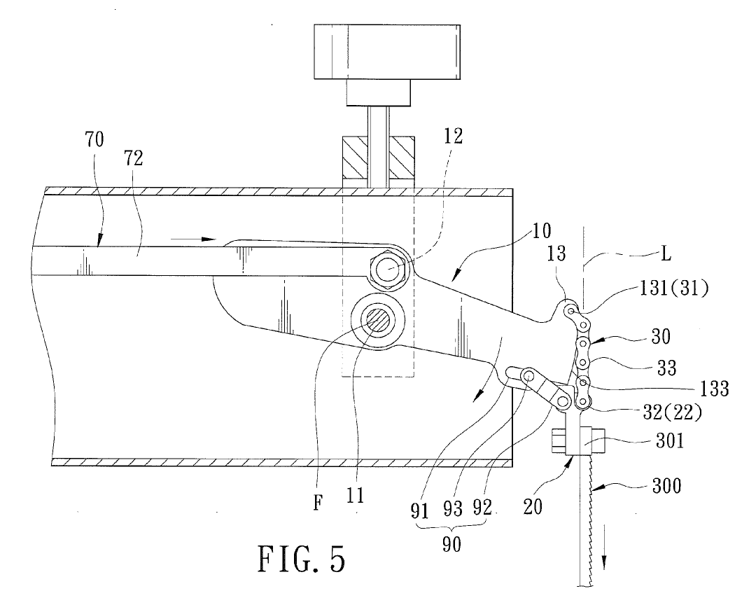

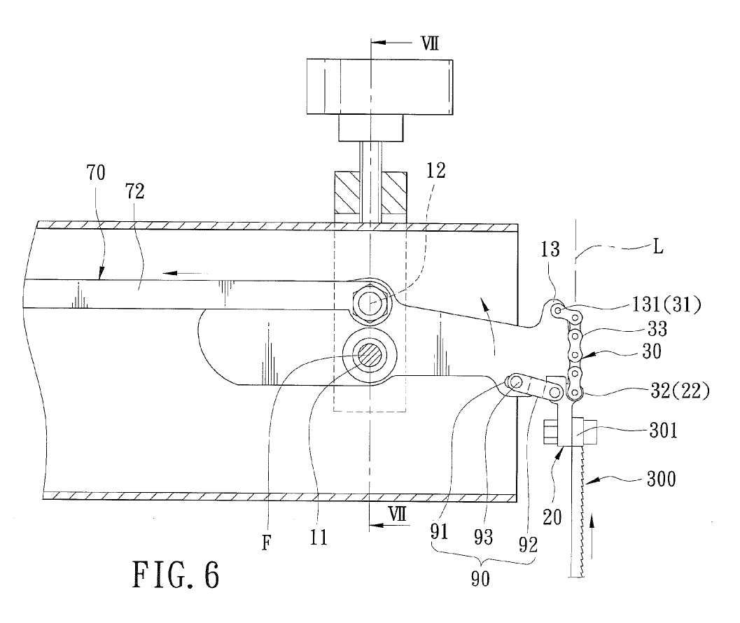

Each of the upper and lower linkage members 30 is in the form of a roller chain, and has a hanging end 31 which is pivotally mounted on the outer region 131 of the respective head body 10 about a pivot axis (X) that is parallel to the fulcrum axis (F), a holding end 32 which is connected to the connecting end 22 of the corresponding straightening member 20, and a linking segment 33 which defines with the holding end 32 a straight line (L) that is parallel to the running path of the saw blade 300. The linking segment 33 is configured to contact the engaging surface 133. Thus, as shown in FIGS. 5 and 6, when the outer region 131 of the respective head body 10 is turned about the fulcrum axis (F), the linking segment 33 is lifted or lowered along the straight line (L) by virtue of pivoting movement of the hanging end 31 about the pivot axis (X) so as to remain in the straight line (L) with the holding end 32. Alternatively, each of the upper and lower linkage members 30 may be a steel cord.

In addition, the driving device further comprises upper and lower anchoring members 90, each of which includes a slot 91, a pair of lugs 92, and a key 93. The slot 91 is disposed in the inner region 132 of the respective head body 10, and is elongated in the longitudinal direction. Each lug 92 has a pivoted end 921 which is pivotally connected to the respective straightening member 20, and a slideable end 922 disposed proximate to the slot 91. The key 93 is disposed on the slideable ends 922 of the lugs 92 to be slideably engaged in the slot 91 so as to accommodate horizontal movement of the respective straightening member 20 relative to the nose segment 13 when the outer region 131 of the respective head body 10 is turned about the fulcrum axis (F), and to guard against movement of the respective straightening member 20 relative to the nose segment 13 in the upright direction.

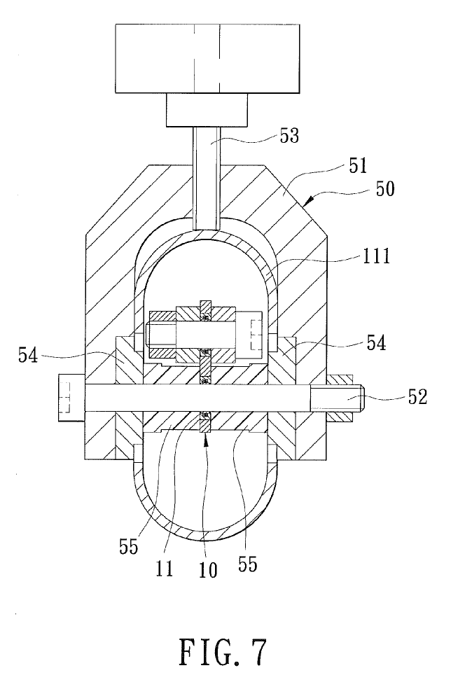

Referring to FIG. 7, the blade tension adjusting unit 50 includes a support frame 51 which is mounted on and which is movable relative to the cantilevered frame segment 111 in the upright direction, a transmitting shaft 52 which is mounted on the support frame 51 and which extends through the pivoted region 11 of the upper head body 10 in the transverse direction, and an operating bolt 53 which threadedly engages the support frame 51 and which abuts against the cantilevered frame segment 111 such that threaded movement of the operating bolt 53 results in movement of the support frame 51 in the upright direction so as to move the pivoted region 11 of the upper head body 10 in the upright direction relative to the lower head body 10 through the transmitting shaft 52, thereby adjusting the tension of the saw blade 300. In addition, two guiding blocks 54 are sleeved on the transmitting shaft 52 and cooperate with the cantilever frame segment 111 to guide movement of the transmitting shaft 52 and the upper head body 10 in the upright direction. Two guarding blocks 55 are sleeved on the transmitting shaft 52 and are disposed between the guiding blocks 54 to guard against movement of the upper head body 10 along the transmitting shaft 52.

As illustrated, by virtue of the engagement of the upper and lower linkage members 30 and the upper and lower anchoring members 90, the connecting ends 22 of the upper and lower straightening members 20 can be moved with the holding ends 32 of the upper and lower linkage members 30 along the straight line (L) to result in stable reciprocating movement of the saw blade 300 along the running path. Moreover, in case one of the upper and lower linkage members 30 is undesirably detached from the corresponding head body 10, by means of the anchoring members 90 which interconnect the head bodies 10 and the straightening members 20, substantial movement of the straightening member 20 relative to the head body 10 can be prevented.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A driving device for a scroll sawing machine which includes an upright frame segment, a cantilevered frame segment extending forwardly from an upper end of the upright frame segment, an underlying frame segment extending forwardly from a lower end of the upright frame segment and spaced apart from the cantilevered frame segment in an upright direction to define a working space, and a saw blade which has upper and lower tightened ends and which is disposed forwardly of the working space, the saw blade being straightened so as to be moved reciprocatingly along a running path in the upright direction, said driving device comprising:
a linking member which has upper and lower linking ends;
an upper arm adapted to extend along the cantilevered frame segment, and having an upper linked end which is coupled to said upper linking end, and an upper actuating end which is opposite to said upper linked end in a longitudinal direction that is transverse to the upright direction;
a lower arm adapted to extend along the underlying frame segment, and having a lower linked end which is coupled to said lower linking end, and a lower actuating end which is opposite to said lower linked end in the longitudinal direction;
a drive unit disposed to synchronously deliver upper and lower reciprocating forces to move said upper and lower arms respectively;
a head body unit including upper and lower head bodies, each having a pivoted region which is adapted to be pivotally mounted on a respective one of the cantilevered and underlying frame segments about a fulcrum axis, and an anchored region which is connected to a respective one of said upper and lower actuating ends of said upper and lower arms, each of said upper and lower head bodies being configured to extend forwardly to terminate at a nose segment which has outer and inner regions opposite to each other in the upright direction, said outer region being turnable about the fulcrum axis;
a saw-blade straightening unit including upper and lower straightening members, each having a securing end that is adapted to grip a respective one of the upper and lower tightened ends of the saw blade, and a connecting end that is opposite to said securing end; and
a linkage unit including upper and lower linkage members, each including a hanging end which is connected to said outer region of a respective one of said upper and lower head bodies, a holding end which is connected to said connecting end of a corresponding one of said upper and lower straightening members, and a linking segment which defines with said holding end a straight line that is parallel to the running path such that, when said outer region of the respective one of said upper and lower head bodies is turned about the fulcrum axis, said linking segment is lifted or lowered so as to remain in the straight line with said holding end.

2. The driving device according to claim 1, wherein each of said upper and lower linkage members is in the form of a roller chain.

3. The driving device according to claim 1, wherein said hanging end is pivotally mounted on said outer region of the respective one of said upper and lower head bodies about a pivot axis that is parallel to the fulcrum axis, said nose segment of each of said upper and lower head bodies having an engaging surface which faces forwardly, which is in contact with said linking segment, and which is configured such that, when said outer region of the respective one of said upper and lower head bodies is turned about the fulcrum axis, said linking segment is lifted or lowered along the straight line by virtue of pivoting movement of said hanging end about the pivot axis relative to said outer region.

4. The driving device according to claim 3, further comprising upper and lower anchoring members, each of which interconnects said inner region of the respective one of said upper and lower head bodies and the respective one of said upper and lower straightening members, and is configured to guard against movement of the respective one of said upper and lower straightening members relative to said nose segment in the upright direction when said connecting end is moved with said holding end of the respective one of said upper and lower linkage members along the straight line.

5. The driving device according to claim 4, wherein each of said upper and lower anchoring members includes
a slot disposed in said inner region of the respective one of said upper and lower head bodies, and elongated in the longitudinal direction,
a lug having a pivoted end which is pivotally connected to the respective one of said upper and lower straightening members, and a slideable end disposed proximate to said slot, and
a key disposed on said slideable end and to be slideably engaged in said slot so as to accommodate horizontal movement of said connecting end relative to said nose segment when said outer region is turned about the fulcrum axis.

6. The driving device according to claim 1, wherein said securing end of each of said upper and lower straightening members has a left jaw wall which extends in the longitudinal direction, a right jaw wall which is movable relative to said left jaw wall in a transverse direction relative to the longitudinal and upright directions so as to cooperate with said left jaw wall to grip a respective one of the upper and lower tightened ends of the saw blade, and a locking member which is operable to move said right jaw wall toward said left jaw wall.

7. The driving device according to claim 6, wherein said locking member has a cam mechanism which is configured such that turning of said locking member results in displacement of said right jaw wall in the transverse direction.

8. The driving device according to claim 1, further comprising a blade tension adjusting unit which is disposed to move said pivoted region of said upper head body in the upright direction relative to said lower head body so as to adjust tension of the saw blade.

9. The driving device according to claim 8, wherein said blade tension adjusting unit includes a support frame adapted to be movable relative to the cantilevered frame segment in the upright direction, a transmitting shaft mounted on said support frame and extending through said pivoted region of said upper head body in a transverse direction relative to the longitudinal and upright directions, and an operating bolt threadedly engaging said support frame and adapted to abut against the cantilevered frame segment such that threaded movement of said operating bolt results in movement of said support frame in the upright direction so as to move said pivoted region of said upper head body through said transmitting shaft in the upright direction.
